(19) United States
(12) Patent Application Publication
(10) Pub. No.: US 2023/0327417 A1
(43) Pub. Date: Oct. 12, 2023

(54) PEER TO PEER DISTRIBUTION AND PV COMBINER BOX

(71) Applicant: Grid Mover Inc., Orem, UT (US)

(72) Inventors: Jeffrey Nelson HEINER, Salt Lake City, UT (US); Jacob Isaac CAMPBELL, Sandy, UT (US); Gigi Marie CAVANAUGH, Salt Lake City, UT (US)

(21) Appl. No.: 18/122,879

(22) Filed: Mar. 17, 2023

Related U.S. Application Data
(60) Provisional application No. 63/406,886, filed on Sep. 15, 2022.
(60) Provisional application No. 63/321,417, filed on Mar. 18, 2022.

(51) Int. Cl. H02J 3/00; H02J 3/38; H02B 1/40; H02G 3/16; H02S 40/34; H02J 3/02; H02B 1/56

(52) U.S. Cl. CPC H02G 3/16; H02B 1/40; H02B 1/56; H02J 3/0073; H02J 3/02; H02J 3/381; H02S 40/34; H02J 2300/24; H02J 2300/28

(57) ABSTRACT

A power junction device is configured to receive variable power from a set of renewable power sources and to provide that variable power to a receiving device. The device includes an electrical junction comprising first and second panel leads. The first lead is configured to connect to a downstream of the set of renewable power sources and to receive the variable power generated by the set of renewable power sources. The second lead is configured to connect to an upstream of the set of renewable power sources. The device includes a load disconnect electrically coupled to the electrical junction and configured to prevent arcing when opening or closing a circuit. The device includes a first connector configured to parallelly connect to another power junction device. The device also includes a second connector electrically coupled to the receiving device and configured to provide the variable power to the receiving device.

### CROSS-REFERENCE TO RELATED APPLICATIONS

This application claims the benefit of and priority to United States Provisional Patent Application Serial No. 63/321,417 filed on Mar. 18, 2022 and entitled “Peer to Peer Distribution and PV Combiner Box,” and also claims the benefit of and priority to United States Provisional Patent Application Serial No. 63/406,886 filed on Sep. 15, 2022 and entitled “Peer to Peer Distribution and PV Combiner Box,” and which applications are expressly incorporated herein by reference in their entirety.

### BACKGROUND OF THE DISCLOSURE

### 1. Technical Field

The present disclosure relates to power junction devices for peer-to-peer power distribution, and, in particular, to power junction devices for receiving variable power and providing the variable power to receiving devices.

### 2. Background and Relevant Art

Traditional US power grids typically generate single-phase 120-volt alternating current (AC) power, as shown by the AC power grid 100 of FIG. 1. For instance, if an oscilloscope were to be connected to an outlet on an American home, the measured power would appear to mimic a sine wave. Typically, the sine oscillates between about 170 V and -170 V, resulting in an effective voltage being between about 110 V and 120 V. The sine wave also oscillates at a rate of about 60 Hz.

As indicated above, power whose current oscillates is referred to as alternating current (AC) power. On the other hand, power whose current does not oscillate is referred to as direct current (DC). With DC power, the electrons flow in only a single direction.

Power grids are nearly always synchronized with one another. Each power grid typically includes a power station, electrical substations, power transmission lines, and power distribution equipment.

Traditional power grid systems provide a static unchanging voltage system. Such systems are designed or optimized to allow efficient transmission of power as well as for efficient power generator synchronization. The systems can also be used by standardized appliances by the end-user of the power grid. As mentioned above, traditional systems provide static voltage/frequency and essentially unlimited power. Such systems, however, also require power generators with generator synchronization. That is, power directly from the generator typically cannot be used directly by end-users; instead, certain electronic equipment, such as a power converter, an inverter, a transformer, or a power signal synchronizer is often required. Much of the cost associated with generating power is attributed to these additional devices (e.g., perhaps as much as 254-port power junction device of the system cost). A significant amount of the cost is also attributed to power transmission. That is, because traditional systems are fixed in place, the power generated by those systems has to be transported to areas where it can be used via power transmission lines, thereby increasing costs.

The fixed location also makes the whole system a single point of failure. Indeed, if one line were to go down, then everything downstream will be without power, thereby requiring massive and expensive maintenance crews.

Traditional power systems also require an earth ground. As such, traditional systems are immobile. Traditional systems further require a house panel, meter, and circuit breaker box. Such equipment also leads to increasing costs.

Despite power grids being generally widespread, in 2016, statistically speaking, over one billion people still were not connected to a power grid. The number of people who are not connected to a power grid has declined over time, but there are still countless millions of people who go without power every day. What is needed, therefore, is an improved technique for providing power to individuals.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments disclosed herein relate to a power junction device configured to receive variable power from a renewable power source and to provide the variable power to a receiving device, and to a power generation system for generating and providing power.

In some embodiments, the power junction device includes an electrical junction comprising a first panel lead and a second panel lead. The first panel lead is configured to connect to a downstream of the set of renewable power sources and to receive the variable power generated by the set of renewable power sources. The second panel lead is configured to connect to an upstream of the set of renewable power sources. The power junction device also includes a load disconnect electrically coupled to the electrical junction and configured to prevent arcing when opening or closing a circuit powered by the variable power. The power junction device also includes a first connector configured to parallelly connect to another power junction device. The power junction device also includes a second connector electrically coupled to the receiving device and configured to provide the variable power to the receiving device.

In another embodiments, the power generation system includes a set of renewable power sources and a power junction device. The set of renewable power sources generates power. The power junction device is electrically coupled to the set of renewable power sources and configured to receive variable power from the set of renewable power sources and to provide the variable power to a receiving device. The power junction device includes an electrical junction, a load disconnect, a first connector, and a second connector. The electrical junction includes a first panel lead and a second panel lead. The first panel lead is configured to connect to a downstream of the set of renewable power sources and to receive the variable power generated by the set of renewable power sources, and the second panel lead is configured to connect to an upstream of the set of renewable power sources. The load disconnect is electrically coupled to the electrical junction and configured to prevent arcing when opening or closing a circuit powered by the variable power. The first connector is configured to parallelly connect to another power junction device, and the second connector is electrically coupled to the electrical junction and configured to provide the variable power to the receiving device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a conventional alternating current (AC) power grid system.

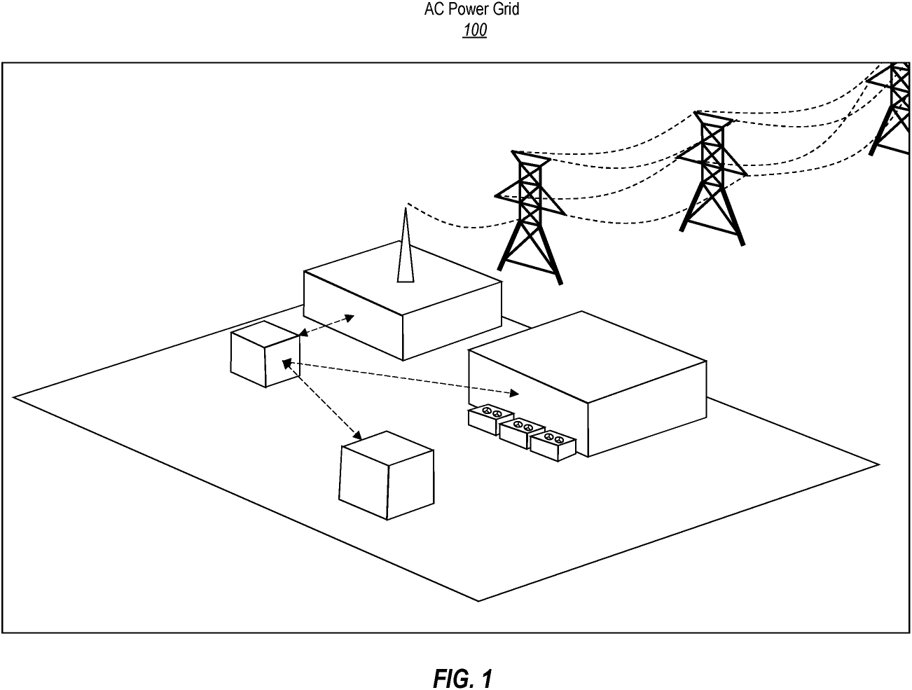

FIG. 2 illustrates various renewable power sources.

FIG. 3 illustrates another renewable power source.

FIG. 4 illustrates an example of a solar panel, which includes a back-feed diode.

FIG. 5 illustrates a graphical representation of a set of solar panels in connection with a power junction device (i.e., a power junction device) according to embodiments of the present disclosure.

FIG. 6 illustrates a graphical representation of an example of a power junction device according to embodiments of the present disclosure.

FIG. 7 illustrates a graphical representation of another example of a power junction device according to embodiments of the present disclosure.

FIG. 8 illustrates a graphical representation of peer-to-peer configuration of power junction devices and solar panels according to embodiments of the present disclosure.

FIG. 9 illustrates a graphical representation of peer-to-peer configuration of a power junction device providing variable DC power to a receiving device according to embodiments of the present disclosure.

FIG. 10 illustrates schematic diagrams of a power junction device with a disconnect according to embodiments of the present disclosure.

FIG. 11 illustrates schematic diagram of port types of a power junction device according to embodiments of the present disclosure.

FIG. 12 illustrates schematic diagrams of a power junction device with a single bus disconnect according to embodiments of the present disclosure.

FIG. 13 illustrates schematic diagrams of a power junction device tied with a power grid according to embodiments of the present disclosure.

FIG. 14 illustrates a schematic diagram of a power junction device with a single bus disconnect according to embodiments of the present disclosure.

FIG. 15 illustrate a schematic diagrams of a power junction device with a dual bus disconnect according to embodiments of the present disclosure.

FIG. 16 illustrates architectural diagrams of a power junction device according to embodiments of the present disclosure.

FIG. 17 illustrates peer-to-peer power coupling via power junction devices tied with a power grid according to embodiments of the present disclosure.

FIG. 18 illustrates peer-to-peer power diverting via power junction devices tied with a power grid according to embodiments of the present disclosure.

FIG. 19 illustrates a peer-to-peer power grid splitting via power junction devices tied with a power grid according to embodiments of the present disclosure.

FIG. 20 illustrate illustrates a peer-to-peer power grid with appliances on variable voltage DC via power junction devices according to embodiments of the present disclosure.

FIG. 21 illustrates a block diagram of an example of a mini power junction device according to embodiments of the present disclosure.

FIG. 22 illustrates a graphical diagram of a mini power junction device with solar panels in a vertical position according to embodiments of the present disclosure.

FIG. 23 illustrates a graphical diagram of a mini power junction device with solar panels in a horizonal position according to embodiments of the present disclosure.

### DETAILED DESCRIPTION

Embodiments disclosed herein relate to a power junction device (i.e., a so-called “power junction” device) configured to receive variable power from a renewable power source and to provide that variable power to a receiving device. In some cases, the power junction device can also operate in direct current (DC) or alternating current (AC) power. The power junction device provides a unified interface that effectively mimics all of the intermediary infrastructure used to deliver power to a receiving device. Further, the disclosed power junction device enables direct drive or direct coupling between the receiving device and one or more solar panels or some other renewable energy sources.

In some embodiments, the power junction device includes an electrical junction having first and second panel leads. The first panel lead is configured to connect to a set of solar panels arranged in series with one another to generate variable DC power. The first panel lead connects to the solar panels downstream relative to a back-feed diode. The second panel lead is configured to connect to the solar panels upstream relative to the back-feed diode. The power junction device also includes a load disconnect (e.g., a bus bar that is disconnectable) that prevents arcing. The power junction device also includes a first connector structured to receive second variable DC power from a second set of solar panels. The first connector is connected to the electrical junction in a peer to peer linking manner (e.g., a peer-to-peer bus connection) so as to cause the second set of solar panels to be arranged in parallel with the set of solar panels. As a consequence, the second set of solar panels provides additional amperage while maintaining a desired voltage level (e.g., 12V, 24V, between 110 V and 120 V, or any required voltages). The power junction device also includes a second connector structured to provide at least the variable DC power to the receiving device. With the solar panels being connected in series, the resulting power is also synchronized.

### Examples of Technical Benefits, Improvements, and Practical Applications

The following section outlines some example improvements and practical applications provided by the disclosed embodiments. It will be appreciated, however, that these are just examples only and that the embodiments are not limited to only these improvements.

The disclosed embodiments provide a unified interface (i.e., the power junction device, also known as a “mimic” device) that can be connected to a set of solar panels or to some other renewable power source. This unified interface can also be connected to a receiving device (e.g., appliances, tools, etc.). As a result of the configuration of the power junction device, receiving devices can be powered without having to be connected to a traditional power grid. Furthermore, inasmuch as the power junction device has a relatively small form factor and inasmuch as some solar panels can be portable, the disclosed embodiments are beneficially, portably able to provide power at remote locations that might not be connectable to a power grid.

It is also often the case that solar panels connected to a residence household fail to provide power to the house when the grid is offline. By hooking the disclosed power junction device to the roof-top solar panels, those solar panels can continue to provide power even when the grid is offline or the power is out.

The disclosed “power junction” device is a portable, generator-centric, memetic power grid device. The power junction device is operable over a variable voltage/frequency system. In some cases, the power junction device can direct as much as 15 to 20 amps to a receiving device.

The disclosed power junction device is designed and optimized to allow easy, inexpensive, reliable use of a power generator. The power junction device is also easily portable and will work with numerous existing household appliances. In some cases, the power junction device can be beneficially used with one and only one power generator without synchronization, thereby capitalizing on the native use of the generator.

The power junction device requires no power itself. Further, it does not require power generator synchronization, inverters, or signal synchronization. The disclosed power junction device is a classical electrically wired device and does not require additional electronics.

The power junction device can be attached in place of a traditional circuit breaker. Further, the power junction device can optionally have a single power generator on the system. Optionally, multiple generators can be put in series or in parallel to appear as a single electrical connection. In this manner, any number of solar panels or wind/water turbines can be arranged in serial and/or in parallel to provide power.

As another benefit, the disclosed power junction device has substantially no power transmission loss. Beneficially, the power junction device uses the most inexpensive portion of the power grid for transmission, which is the 15/20 amp branch circuit of a standard household panel. Due to its form factor, the power junction device is easily portable and can be fabricated in a generally inexpensive manner because no power lines, substations, massive transformers, or massive power plants are needed to build or breakdown power signals.

Advantageously, the disclosed embodiments do not require an earth ground system. As such, the power junction device can be portable and can even be used in space.

The power junction device can be used in a versatile manner and can be hooked up to power generators that follow different standards. For example, in the U.S., the standard is 120 V at a plug, while, in some other countries (e.g., Singapore, Sweden, South Korea, United Kingdom, etc.), the standard is 220-240 Volts at a plug. Beneficially, the power junction device is standard agnostic.

As another benefit, the same physical device supports either AC or DC use. The AC version can be designed for a water/wind/turbine or other AC generation. Such a configuration allows for a variable AC voltage, taking any voltage from 0 up to the specified max of 120/240 V. However, some embodiments can allow for a 204-port power junction device over the standard voltage. Such a configuration also allows for a variable frequency and wave shape (a sine wave is generally used, as it is the closest to the power grid).

The DC version can be designed for a solar, chemical reaction, or other DC generation. Such a configuration allows for a variable DC voltage, taking any voltage from 0 up to the specified max of 120 V; however, some embodiments can allow for a 204-port power junction device over the standard voltage. Because a variable voltage system can be used, a wave shape may or may not appear in the DC signal. Instead, DC-to-DC converters may be used to convert the variable DC voltage to several different DC voltages as required.

Both the AC and DC versions allow for use with existing appliances. The devices on the following lists may be different for the AC/DC versions. As an example, category A appliances include existing appliances without modification that work “out-of-the-box.” These tend to be ones that use coils, neon lights, and plug in features (i.e., no switches). Category B appliances include existing appliances without modification that work if used in a certain way. Category C appliances include all other appliances. Such devices may burn out or simply will not work without modification, though some can be easily modified to work (e.g., by plugging in a classic inverter system). Accordingly, these and numerous other benefits will be described in more detail in the following sections with one or more power junction devices.

### Renewable Power Sources That Provide Variable DC Power

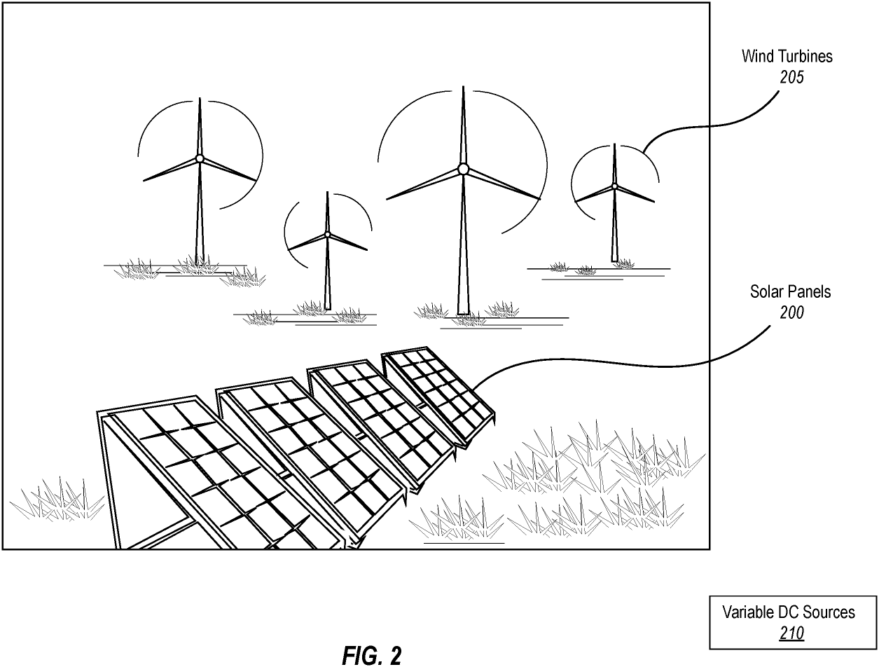

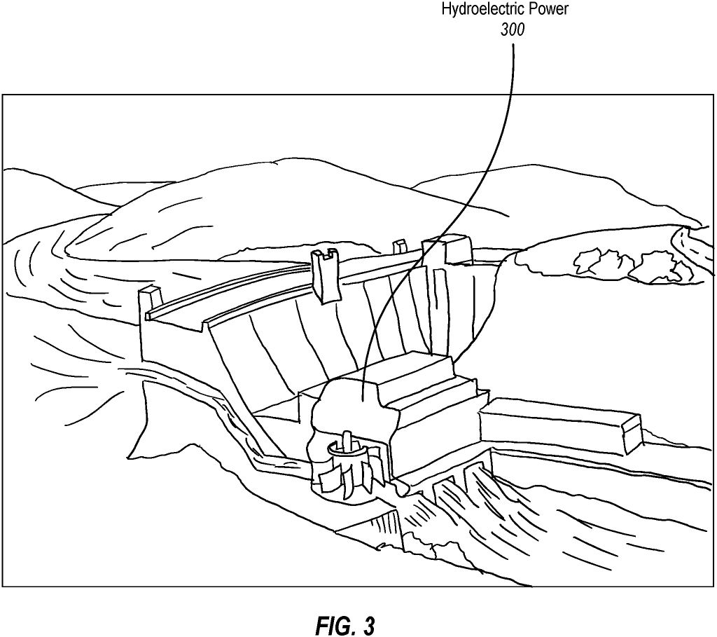

Attention will now be directed to FIGS. 2 and 3, which illustrate various types of renewable energy sources 200, 205, 210, and 300. To illustrate, FIG. 2 shows a set of solar panels 200 as well as a set of wind turbines 205. The solar panels 200 are structured to convert light energy into electrical energy. The wind turbines 205 are structured to convert wind energy into electrical energy. The solar panels 200 and the wind turbines 205 are considered to be variable DC sources 210 because they produce DC power, but the amount of that DC power will fluctuate over time (i.e., will be variable) based on the amount of energy, incident angle, duration of the sun light, speed of wind, duration of the wind, etc.

For instance, the solar panels 200 will continue to produce DC power while the sun is shining on the panels. They will stop producing energy, however, when the sun sets. Similarly, the amount of energy they produce will be reduced if the sun is obfuscated, such as by clouds.

The wind turbines 205 will produce energy while the wind is blowing a sufficient amount to cause the blades to spin. Faster spin rates can produce more energy. In this sense, these DC sources are variable as opposed to being constant due to the nature of the weather.

FIG. 3 shows another renewable energy source in the form of a hydroelectric dam 300. So long as water flows through the dam’s channels, the water rotates generators of the dam thereby producing AC energy. Due to weather conditions and management of water supply, the hydroelectric dam 300 may not be able to consistently produce AC power.

### Solar Panels

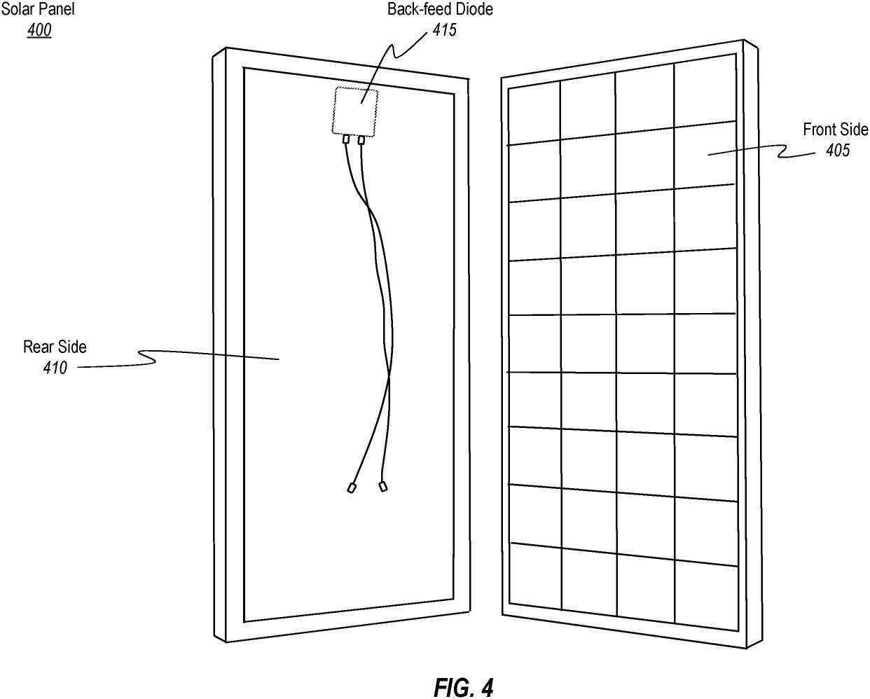

Attention will now be directed to FIG. 4, which shows an example of a solar panel 400. The remaining portions of this disclosure will focus on the use of the solar panel 400 to provide variable DC power, but one will appreciate how any of the power sources mentioned herein as well as any other sources of DC power can be used herein.

Most solar panels are configured to output 12 V or 24 V. It is typically the case, however, that solar panels are overpowered by 4-port power junction device or perhaps even 5-port power junction device. Therefore, a 12 V panel might actually be able to produce 18 V or perhaps even 20 V. Similarly, a 24 V panel might actually be able to produce 35 V or even 40 V. If three panels were connected in serial, and each panel could produce 40 V, then a 120 V output will be produced.

The solar panel 400 is shown as including a front side 405, which will be directed towards the sun, and a rear side 410. The front side 405 of the solar panel 400 includes numerous photovoltaic cells, which are configured to convert light energy into electrical energy and are connected in parallel or series to produce a range of DC voltages, for example, from 20 V to 40 V.

The solar panel 400 operates in a way that light photons provide energy to electrons of atoms so as to be free from the atoms. Based on movements of the free electrons, electrical energy is generated.

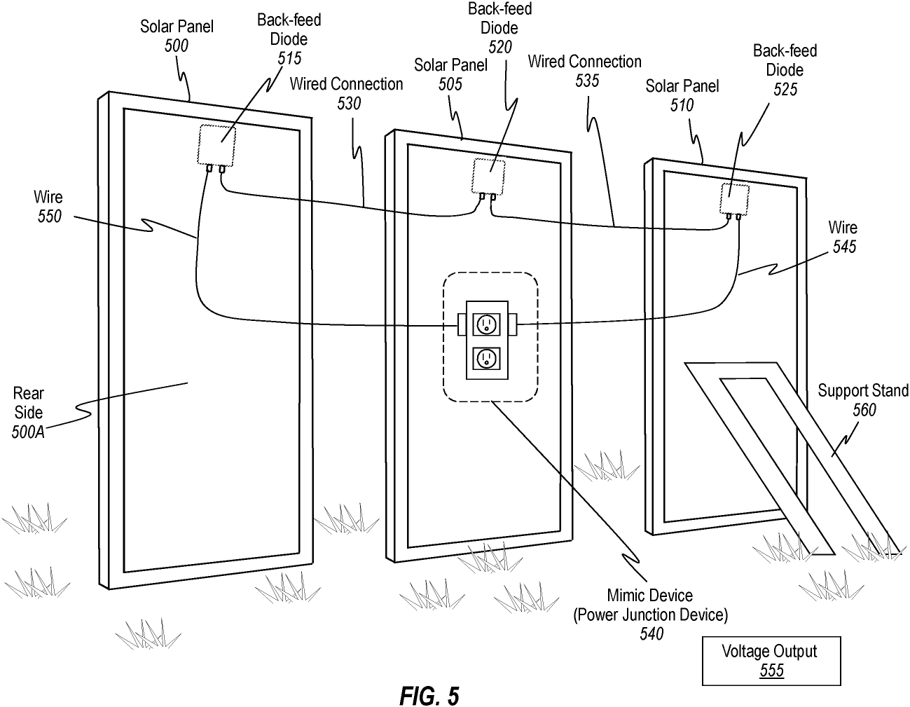

The solar panel 400 is also shown as including a back-feed diode 415. The back-feed diode 415 is structured or designed to prevent the reverse flow of current, thereby generating a single flow of energy or DC power. The power or current produced by the solar panel 400 can be delivered via the back-feed diode 415 to a receiving unit via various wires (illustrated but not labeled). In some cases, the wires can be used to connect any number of solar panels in series, parallel, or in any combination with one another by connecting the respective back-feed diodes together, as shown in FIG. 5.

FIG. 5 shows a set of solar panels that includes solar panels 500, 505, and 510, which are oriented with the rear side 500A being viewable. Although only three solar panels 500, 505, 510 are illustrated, one will appreciate that any number of solar panels can be arranged in series, parallel, or any combination with one another to produce a range of suitable DC voltages. By arranging a sufficient number of 12 V or 24 V solar panels in series or parallel, a desired output voltage level (e.g., 12 V, 24V, between 110 V and 120 V or between 220 V and 240 V) can be achieved.

Each of the solar panels 500, 505, and 510 is equipped with a respective back-feed diode 515, 520, and 525, respectively. In this example, the solar panels 500, 505, and 510 are connected to one another via their respective back-feed diodes 515, 520, and 525 in series. For instance, wired connection 530 connects the output of the back-feed diode 515 to the input of the back-feed diode 520. Similarly, a wired connection 535 connects the output of the back-feed diode 520 to the input of the back-feed diode 525.

Disposed on the rear side of the solar panel 505 is a mimic device 540 (also known as a power junction device). One will appreciate how the power junction device 540 can be placed on any of the solar panels 500, 505, and 510. The output of the back-feed diode 525 is connected to the power junction device 540 via the wire 545. Similarly, the power junction device 540 is also connected to the input of the back-feed diode 515 via the wire 550. As such, the back-feed diodes and the power junction device 540 are connected in series with one another. In a case where a fourth solar panel is needed, a wired connection connects the output of the back-feed diode 525 to the input of the back-feed diode of the fourth solar panel, and the output of the back-feed diode of the fourth solar panel is connected to the power junction device 540 via a wire of the back-feed diode of the fourth solar panel. In another case where more than four solar panels are needed, similar connection patterns can be made with the power junction device 540.

The serial combination of the voltage outputs from at least the solar panels 500, 505, and 510 are provided to the power junction device 540 to produce a desired voltage output 555 (e.g., 12 V, 24 V, between 110 V and 120 V, or between 220 V and 240 V). The back-feed diodes 515, 520, and 525 prevent the back flow of electrons flowing through the circuit.

In some cases, one or more of the solar panels can be equipped with a support stand 560 to enable the solar panels to have at least a partially upright position. The support stand 560 is adjustable to permit varying angles relative to the surface on which the solar panels are disposed. The support stand 560 can be attached to an appropriate position of the rear side of the solar panel so that, when folded down, the solar panel can be easily carried. Further, a support unit may connect the rear side of the solar panel to the stand so that the stand does not extend over a predetermined angle with the rear aide of the solar panel.

As will be described in more detail, some solar panels can also be equipped with folding means (e.g., hinges) to enables the panel to be folded to each other so that they can be stacked, thereby making them easily portable. In some cases, the panels might be constructed of flexible material that enables the panel to be rolled up.

As mentioned earlier, the power junction device 540 is disposed on the rear side of a solar panel. The power junction device 540 is detachably coupled to the rear side. As used herein, the phrase “detachably coupled” means that the power junction device (in some embodiments) is not permanently attached to the rear side of the solar panel. Instead, the power junction device can be removed. Various means can be used to detachably couple the power junction device with solar panels. In some cases, Velcro can be used. In some cases, a latch mechanism can be used. Any other type of non-permanent coupling can be used. In some embodiments, the power junction device 540 can be permanently attached to the rear side of the solar panel.

### Power Junction Device

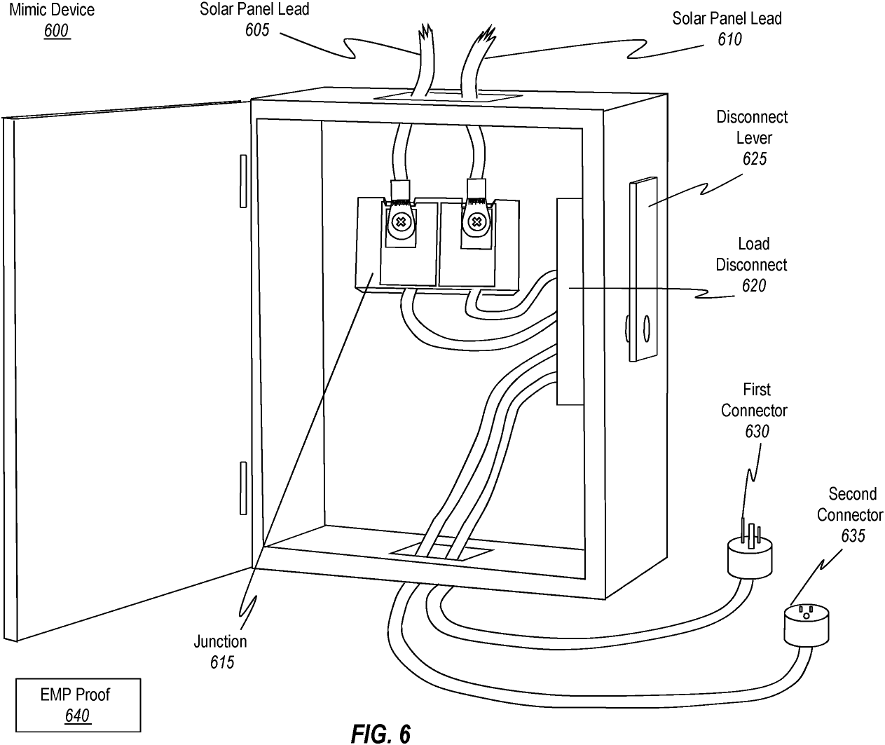

FIG. 6 shows an example power junction device 600, which is representative of the power junction device 540 of FIG. 5. FIG. 6 shows a solar panel lead 605, which is representative of the wire 550 that connects the power junction device 540 to the back-feed diode 515. FIG. 6 also shows a solar panel lead 610, which is representative of the wire 545 that connects the power junction device 540 to the back-feed diode 525.

The solar panel leads 605 and 610 are connected to a junction 615 that is included as a part of the power junction device 600. The junction 615 provides a framework to enable electrical leads or wires to be fixedly connected to a common source. In an embodiment, other renewable power sources may be connected to the power junction device 600. In another embodiment, a combination of solar panels and other renewable power sources may be connected to the power junction device 600, For explaining purposes only, solar panels are described below with the power junction device 600. By simply replacing the solar panels with other renewable power sources, similar configurations may be made with minor adjustments.

The junction 615 is also connected to a load disconnect 620 (e.g., a bus bar that is disconnectable), which is controlled via a disconnect lever 625. Depending on the position of the disconnect lever 625, the load disconnect 620 either opens a circuit or closes the circuit, which provides the power from the solar panels to a receiving device. The load disconnect 620 is specifically configured to prevent arcing when the circuit is opened or closed. In some cases, the load disconnect 620 is a 300 W or 250 W switch. Other switches having different wattage ratings can be used as well.

The power junction device 600 includes a first connector 630 and a second connector 635. The first connector 630 is shown as having a male connector, but a female connector can also be used. Likewise, the second connector 635 is shown as having a female connector, but a male connector can also be used. When the load disconnects 620 is in an open status so that the circuit is open, the first connector 630 and the second connector 635 are disconnected from the solar panels and no DC/AC power is provided to the first and second connectors 630, 635. On the other hand, when the load disconnect 620 is in a closed status so that the circuit is closed, the first connector 630 and the second connector 635 are connected to the solar panels and AC energy is provided to the first and second connectors 630, 635.

The first connector 630 is provided to enable the set of solar panels, which are connected to the power junction device 600 and which are connected in serial with one another, to be connected to a second set of solar panels in a parallel manner, thereby enabling the amperage to be increased without modifying the voltage levels. Further details on this peer-to-peer parallel configuration will be provided later.

The second connector 635 is provided to connect the power junction device 600 to a receiving apparatus or device in order to provide power (e.g., variable DC power or perhaps AC power) to the receiving device. For instance, an electrical grill can be coupled to the second connector 635, and the electrical grill can be powered using the solar panels. Further details on this aspect will also be provided later.

With the configuration shown in FIG. 6, the power junction device 600 is considered to be electro-magnetic pulse (EMP) proof 640. That is, an EMP will essentially have no impact on the power junction device 600.

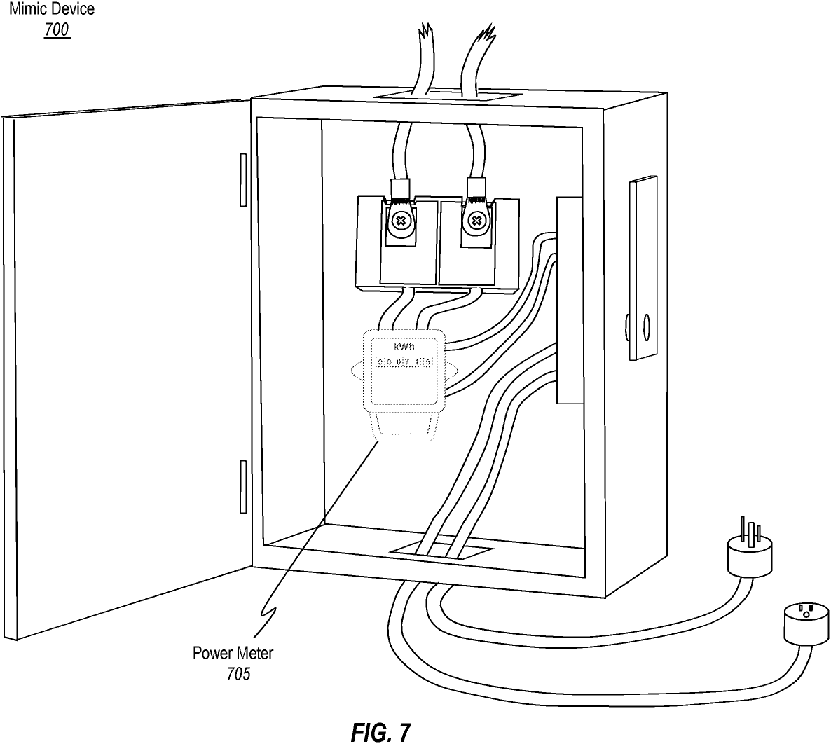

FIG. 7 shows another embodiment of a power junction device 700. Specifically, FIG. 7 shows a power junction device 700 that includes a power meter 705, which is connected between the junction and the load disconnect. The power meter 705 measures the amount of power produced by the solar panels that are connected to the power junction device 700. Alternatively, the power meter 705 is positioned in the circuitry so that it can measure consumption of power by one or more receiving devices. In an embodiment, a power generation meter and a power consumption meter may be included in the power junction device 700. In some cases, the power meter 705 can be an Internet of Things (IoT) device and can provide power reports to an interested entity over a network connection (wired or perhaps wireless connection).

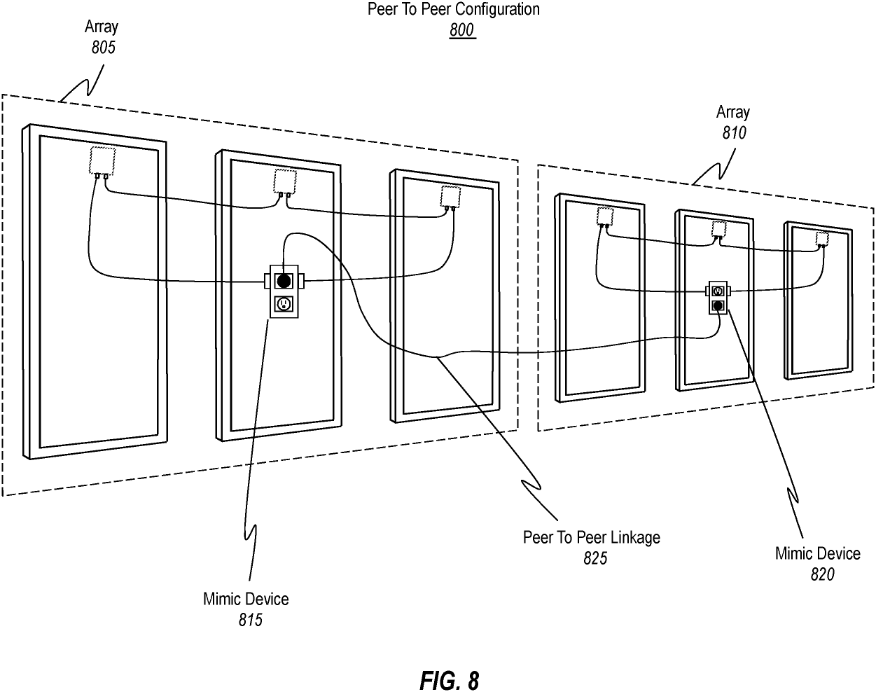

FIG. 8 shows a peer-to-peer configuration 800 (e.g., a peer-to-peer bus connection) where a first array 805 of solar panels are connected in parallel with a second array 810 of solar panels via use of a first power junction device 815 and a second power junction device 820. Here, the power output from the first array 805 of solar panels, where the output is provided through the second connector (e.g., the second connector 635 of FIG. 6) of the power junction device 815, is connected to the power input of the power junction device 820, and the input is provided through the first connector (e.g., the first connector 630 of FIG. 6) of the power junction device 820.

Based on the structure of the power junction device 815, the received power from the power junction device 820 is added in parallel to the power produced by the solar panels included in the first array 805. That is, the power produced by the solar panels in the array 810 is added in parallel to the power produced by the first array 805. By adding the power in parallel, increased amperage can be achieved while maintaining the voltage level within a desired range (e.g., between 110 V and 120 V). The peer-to-peer linkage 825 (e.g., a peer to peer bus connection) shows how the power junction device 820 is electrically parallelly coupled to the power junction device 815. The number of arrays of solar panels may be greater than two based on requirements and adjacent two arrays may be connected in a similar manner as the connection between the arrays 805 and 810.

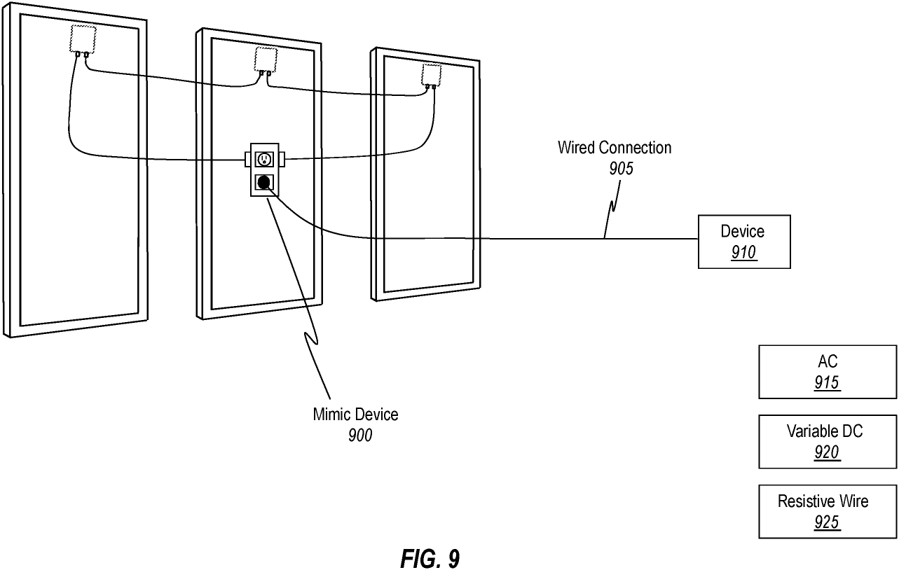

FIG. 9 shows a scenario where the power provided by a set of solar panels is directed through a mimic device 900, which is representative of the power junction devices mentioned herein, and is delivered via a wired connection 905 to a receiving device 910. The receiving device 910 can be any type of device capable of operating on variable DC power. In some cases, the receiving device 910 can be structured to operate on AC power 915 or variable DC power 920. For instance, the receiving device 910 might be a resistive wire device 925, such as a heating element. Accordingly, in some cases, the receiving device 910 can be configured to be powered using DC power or, alternatively, using AC power. The receiving device 910 can be an AC/DC powered device.

As a specific example, the receiving device 910 can be the resistive wire device 925 (e.g., a heating rod). Here, this resistive wire device 925 can be used to heat a tub of water. When the tub of water is heated, that tub can then provide heat to a small enclosure, such as perhaps a greenhouse. Because water retains heat for a prolonged period of time, the hot water can provide sufficient heat for the greenhouse throughout a nighttime period. When the sun rises in the morning, the resistive wire device 925 can again be powered and can again heat the water.

Cost savings can be achieved by using the disclosed principles. If the solar panel configuration were not used, then heating a greenhouse would often require about 600 watts throughout the night, which is about 10 kWh. By using renewable power sources and by coupling the power sources using the disclosed power junction device, the embodiments can beneficially reduce power expenses.

The embodiments also enable for the direct drive of appliances or devices, where the device is driven by the solar panel via use of the disclosed power junction device.

In some cases, the solar panels have hinges that allow those panels to be folded for transportation. In some cases, the solar panels are light enough and are small enough so that they can be easily packed in a backpack and can be taken when traveling outdoors. The user can then have electricity to power an electrical grill when cooking outdoors. In some cases, the solar panels can be made of flexible material to allow the panels to be rolled up.

When multiple solar panel arrays are linked together in a peer-to-peer manner (e.g., a peer to peer bus connection) where the devices share the same bus (e.g., similar to a distribution panel), the disclosed systems can provide 20 amps of power, or perhaps even more, and can provide around 1800 watts. In some cases, 2,000 watts can be generated. In some cases, each individual solar panel might produce about 350 or more watts of power.

In scenarios where the power junction device is EMP proof, the power junction device can be constructed without any silicon. By not having silicon or silicon chips, the power junction device can therefore be EMP proof.

In some embodiments, the load disconnect not only opens the circuit relative to the set of solar panels to which the power junction device is immediately connected, but it also opens the circuit to any peer-to-peer linked arrays of solar panels. In this manner, the load disconnect can open all serial and parallel circuits.

In some implementations, the connecting wires are configured for polarization. The power junction device can also be configured for polarized lines.

In some cases, embodiments include various bus bars that are disconnectable. Optionally, the embodiments avoid using a master feed because each panel can connect to another set of panels. To turn the system off, all of the bus bars inside the unit can be disconnected. By disconnecting the bus bars, all circuits are opened. In this sense, the disclosed embodiments can be viewed as a combination of a distribution panel as well as a photovoltaic (PV) combiner box. It can be viewed as a distribution panel due to its ability to connect to any number of other devices. The power junction device is similar to a circuit panel that includes disconnectable buses with different pots, or circuit breakers. Any number of mimics can also be hardwired to one another or otherwise connected to one another, thereby producing a peer-to-peer network. In some cases, the power junction device further includes an inverter, thereby enabling the power junction device to be plugged into an outlet to provide power to an entity, such as perhaps a house (e.g., when the house is disconnected from a power grid). In some other cases, the power junction device further includes a DC-to-DC converter (e.g., a buck, boost, and buck-boost converter), which converts the provided DC power to a DC power with a desired voltage.

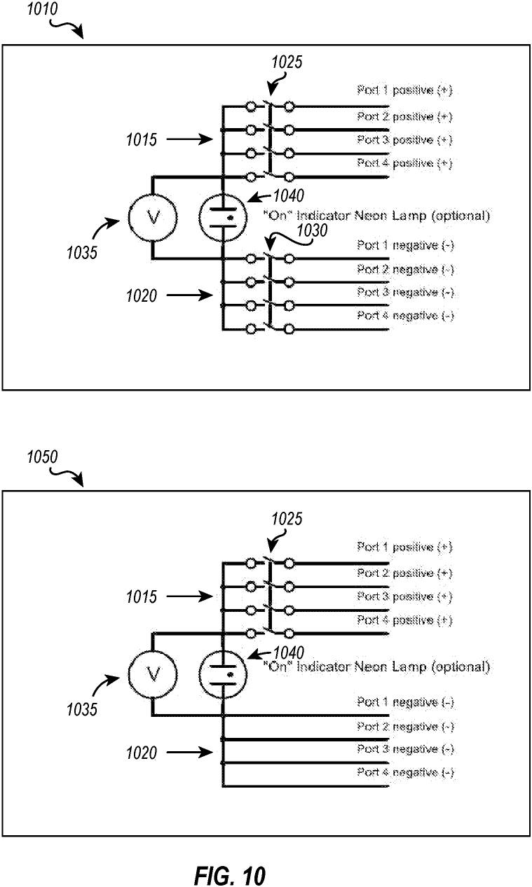

FIGS. 10, 11, 12, 13, 14, and 15 illustrate various supporting architectural diagrams. In particular, these figures show the various buses of the power junction device and how they can be disconnected to thereby open the circuit and prevent the flow of electricity to a receiving unit. The power junction device may have two or more ports, where one is for connecting to the solar panels or power sources, which are grid power or renewable, and the other ports are for connecting to receiving devices. In an embodiment, the power junction device may come with open ports for future extension to other receiving devices. Now referring back to FIG. 10, power junction devices 1010, 1050 include a load disconnect configured to make a connection or disconnection between solar panels and receiving devices. The load disconnect may have a single bus or dual bus. In a scenario where there are four ports in the power junction device, the dual bus disconnect has dual buses, positive bus 1025 (i.e., positive side in FIG. 10) for the positive ports 1015 and negative bus 1020 (i.e., negative side in FIG. 10) for the negative ports 1030, as shown in the top of FIG. 10. Specifically, the positive bus 1025 can make a connection with or disconnection from the four positive ports all at once when the load disconnect is in a connection or disconnection position, respectively.

The positive bus 1025 disconnect may be a single bus in the positive ports in the bottom of FIG. 10. The single bus (i.e., positive bus) 1025 is positioned in the positive ports 1015. By disconnecting the positive bus 1025 from the positive ports 1015, a disconnection can be made.

In embodiments, a bus voltmeter 1035 may be installed between the positive ports 1015 and negative ports 1030 to show how many voltages the solar panels generate and provide to the power junction device 1010, 1050. Further, a light emitting diode (LED) 1040 may be installed to indicate presence or absence of a power connection between the positive ports 1015 and the negative ports 1030. The LED 1040 may be in any form, such as a display, lamp, or audible sound.

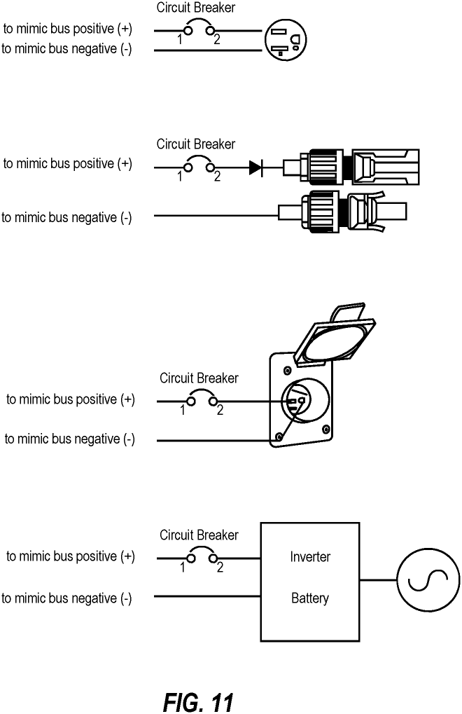

Examples of connections to ports are illustrated in FIG. 11. A female power outlet, a solar panel, a male power inlet, and a power grid are connected to ports of the power junction device as shown from the top to the bottom in FIG. 11. As illustrated, each port is connected to them via a circuit breaker, which is able to disconnect the connection when excessive power greater than the capacity of the circuit breaker is transmitted through the circuit breaker. Since every port is connected via a corresponding circuit breaker, the safety of the power junction device can be improved. Since the circuit breaker is better to be located near the power source, the circuit breakers are all located in the positive port. When the port is connected to a power grid, which supplies AC power, an inverter may convert the AC power to DC power when a receiving device requires DC power. As illustrated in the bottom of FIG. 11, the power grid may be connected to a battery, which is able to save DC power, via an inverter, and the battery may be connected to a receiving device via the power junction device.

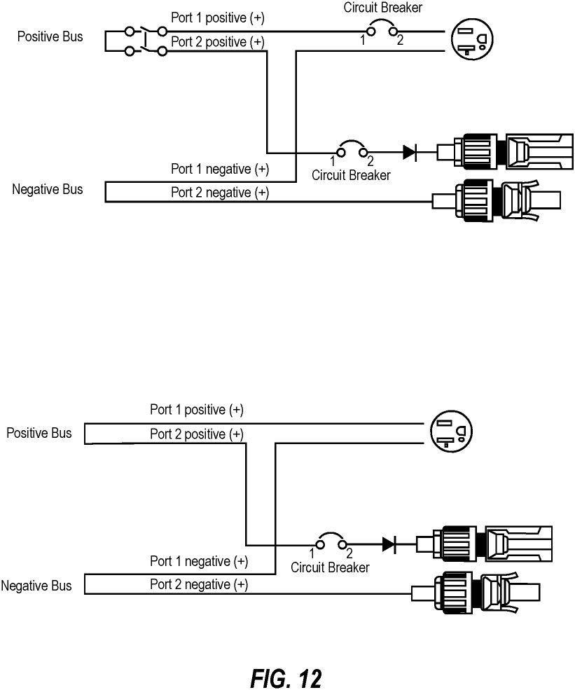

Circuit diagrams for two port connections are illustrated in FIG. 12. In the top, a connector for a solar panel as a power source is connected to a power junction device. A back-feed diode is connected to the positive side of the connector so as to prevent back flow of the current. As described above, since the circuit breaker needs to be located near the power source, the circuit breaker is placed next to the back-feed diode. The positive and negative ports of the solar panel are connected to the second positive and negative ports of the power junction device, respectively. The first positive and negative ports of the power junction device are connected to a standard outlet. Another circuit breaker may be placed between the positive port of the power junction device and the positive terminal of the standard outlet. A single bus load disconnect is also placed in the positive ports of the power junction device.

The load disconnect may not be necessary in the connection between the power source and the power outlet, as shown in the bottom of FIG. 12. Also, another circuit breaker, which is positioned between the positive port of the power junction device and the positive terminal of the outlet, may not be necessary because of the circuit breaker positioned between the second positive port of power junction device and the positive terminal of the power source.

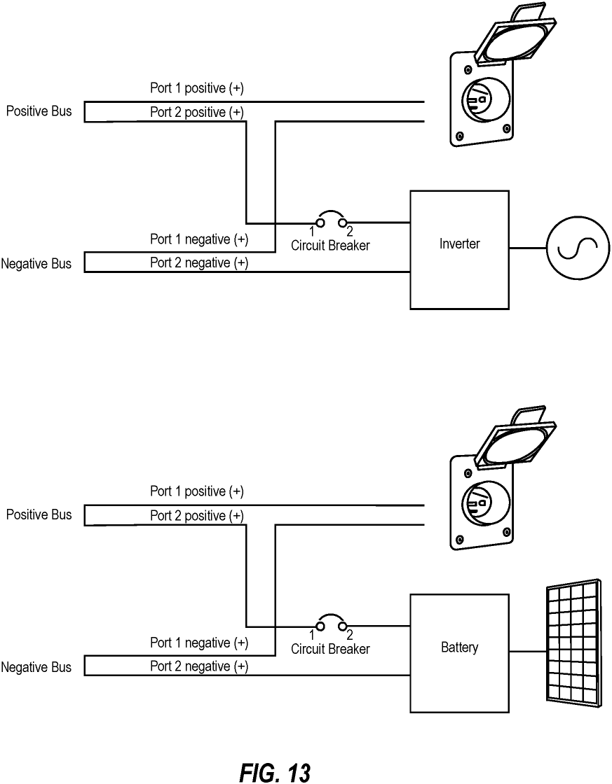

FIG. 13 shows two circuit diagrams, one in the top with a power grid and the other one in the bottom with a standalone system. In the top circuit diagram, a power junction device is connected with a power grid and a power inlet, which is to receive power from the solar panel. In an aspect, the solar panel may include two or more solar panels and may be another power source, such as, a renewable power source, battery, etc. When the DC power generated by the solar panel is relayed to an inverter, the DC power is inverted to AC power by the inverter and provided to the power grid. In this way, generated solar power can be monetized for the benefit of the owner of the solar panel.

In the bottom of FIG. 13, illustrated is a standalone system. From the power inlet, DC power may be received and relayed to a battery. When a receiving device needs AC power, an inverter may convert the DC power from the battery to AC power so that the receiving device can be powered.

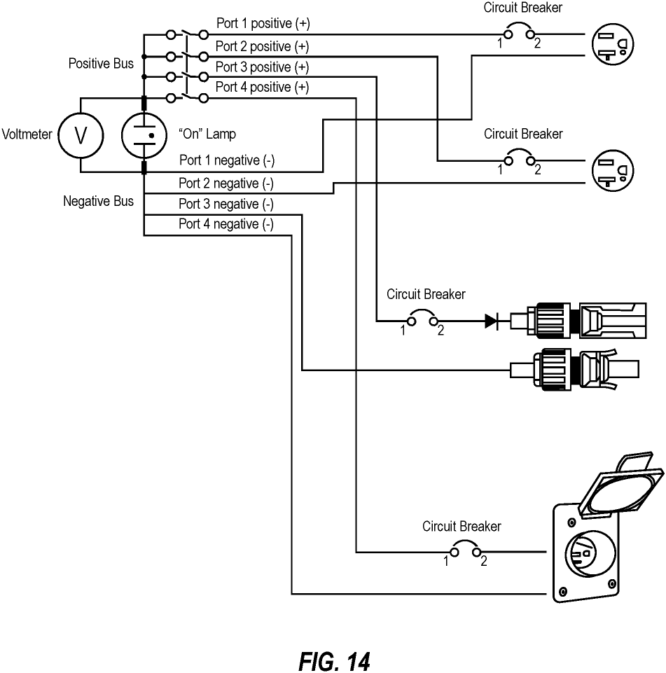

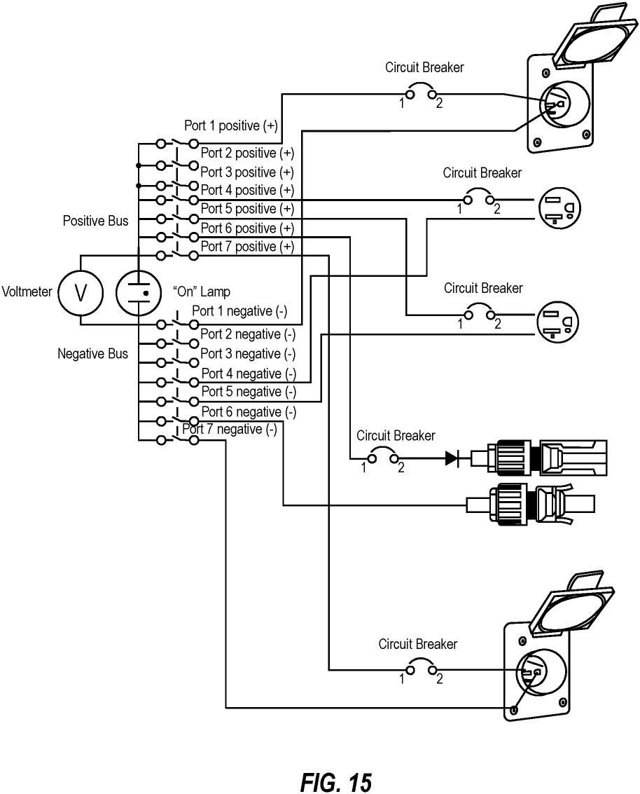

FIGS. 14 and 15 illustrate circuit diagrams with more than 2 ports in power junction devices. Specifically, FIG. 14 shows a power junction device with 4 ports with a single bus load disconnect and FIG. 15 shows a power junction device with 7 ports with a double bus load disconnect. In FIG. 14, two outlets are connected to two ports, a solar panel is connected to the third port, and a power inlet is connected to the fourth port. As illustrated, each port is connected with a circuit breaker. An optional voltmeter and an optional LED indicator are also shown in FIG. 14.

FIG. 15 also illustrates that two outlets are connected to two ports, a solar panel is connected to the one port, and a power inlet is connected to another port, as illustrated in FIG. 14. Additionally, FIG. 15 illustrates another power inlet is connected to one port and two ports are open for future connections. Unlike FIG. 14, a double bus load disconnect is connected to the seven ports. As illustrated, each port is connected with a circuit breaker. An optional voltmeter and an optional LED indicator are also shown in FIG. 15.

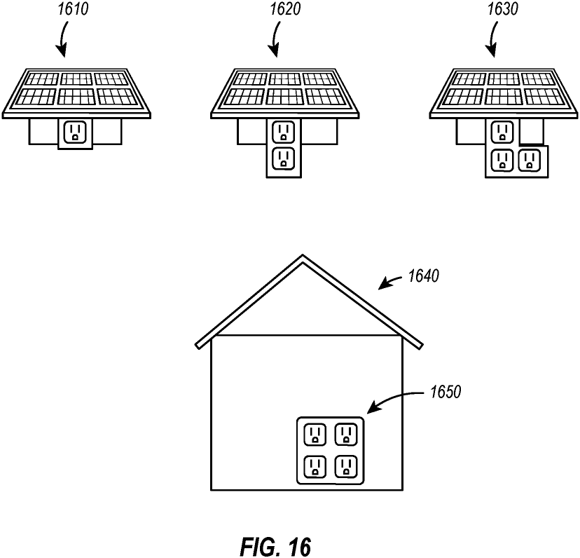

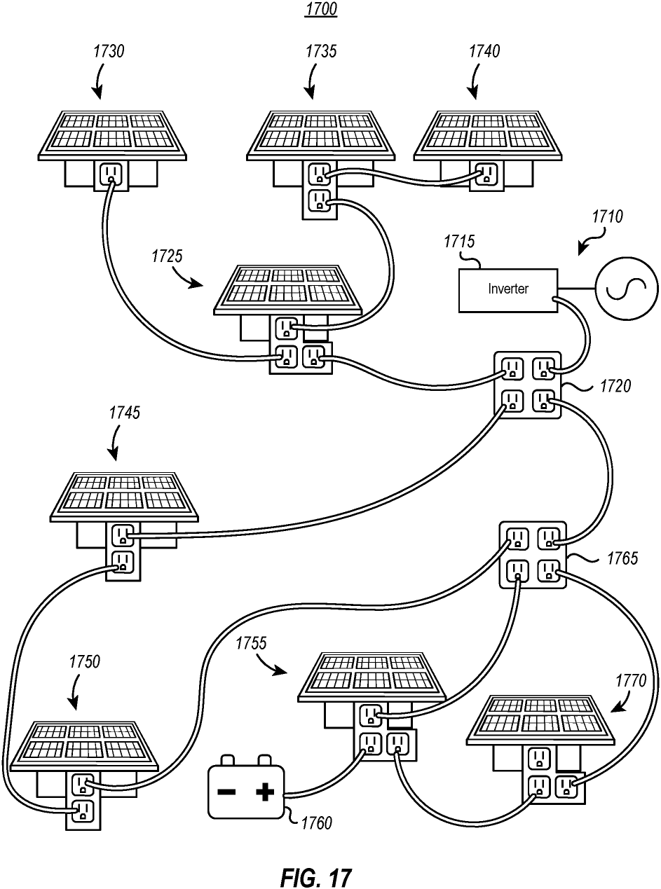

Now, FIGS. 16-20 illustrate various other supporting architectural diagrams. In particular, FIG. 16 illustrates basic elements for a peer-to-peer system, and FIGS. 17-20 illustrate how the power junction device can be coupled to an existing structure (e.g., a house). These figures further illustrate the peer-to-peer connection options.

Examples of basic elements are a 2-port power junction-solar device 1610, a 3-port power junction-solar device 1620, a 4-port power junction-solar device 1630, and a 4-port power junction device 1650. It is noted that the power junction-solar device refers to a device, which includes a power junction device and one or more solar panels electrically coupled to each other These elements may be installed inside or outside of a residential/business establishment 1640. The power junction-solar devices 1610-1630 have one port designated for the solar panel. Thus, the 2-port power junction-solar device 1610 has only one port available for a connection, the 3-port power junction-solar device 1620 has two ports available for connection, and the 4-port power junction-solar device 1630 has three ports available for connection, while the 4-port power junction device 1640 has four ports available for connection.

As illustrated in FIG. 17, a peer-to-peer system 1700 includes a power grid 1710, which is connected to an inverter 1715, which can convert DC power generated by solar panels to AC power so that an owner of solar panels can be benefited. The inverter is then connected to a 4-port power junction device 1720. One port of the 4-port power junction device 1720 is used to make a serial or standard coupling or connection with a 4-port power junction-solar device 1725, a 3-port power junction-solar device 1735, and two 2-port power junction-solar devices 1730 and 1740. Two ports of the 4-port power junction device 1720 are used to make a redundant coupling connection with two 3-port power junction-solar devices 1745 and 1750, two 4-port power junction-solar devices 1755 and 1770, a 4-port power junction device 1765, and a battery 1760.

With regard to the serial coupling or connection, available two ports of the 4-port power junction-solar device 1725 are connected to the 2-port power junction-solar device 1730 and to the 3-port power junction-solar device 1735, and one available port of the 3-port power junction-solar device 1735 is connected to the 2-port power junction-solar device 1740. Due to the nature of serial connection, if one connection is damaged or lost, any other device connected to the damaged connection is also lost. For example, if the connection between the 4-port power junction-solar device 1725 and the 4-port power junction device 1720 is lost, all devices in the serial connection are lost or disconnected from the 4-port power junction device 1720.

Now turning to the redundant coupling or connection, one port of the 4-port power junction device 1720 is connected to the 2-port power junction-solar device 1745, and one available port of the 2-port power junction-solar device 1745 is connected to the 2-port power junction-solar device 1750. One available port of the 2-port power junction-solar device 1750 is connected to the 4-port power junction device 1765, and one port of the 4-port power junction device 1765 is connected back to the 4-port power junction device 1720. Since the connection among the 4-port power junction device 1720, two 2-port power junction-solar devices 1745 and 1750, and the 4-port power junction device 1765 forms a loop or makes a redundant coupling, when one connection between any two devices is lost or damaged, they are still connected to the power grid 1710, thereby increasing connection reliability and increasing maximum power that can be transmitted.

Also, two other ports of the 4-port power junction device 1765 are used to make another redundant coupling with two 4-port power junction-solar devices 1755 and 1770. In this redundant coupling, however, the battery 1760 is serially connected to the 4-port power junction-solar device 1755.

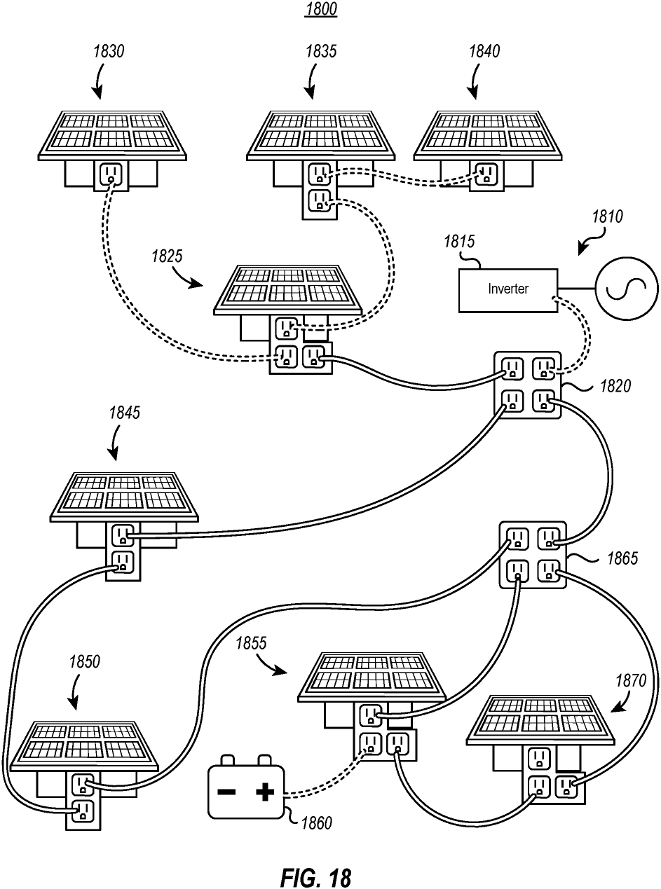

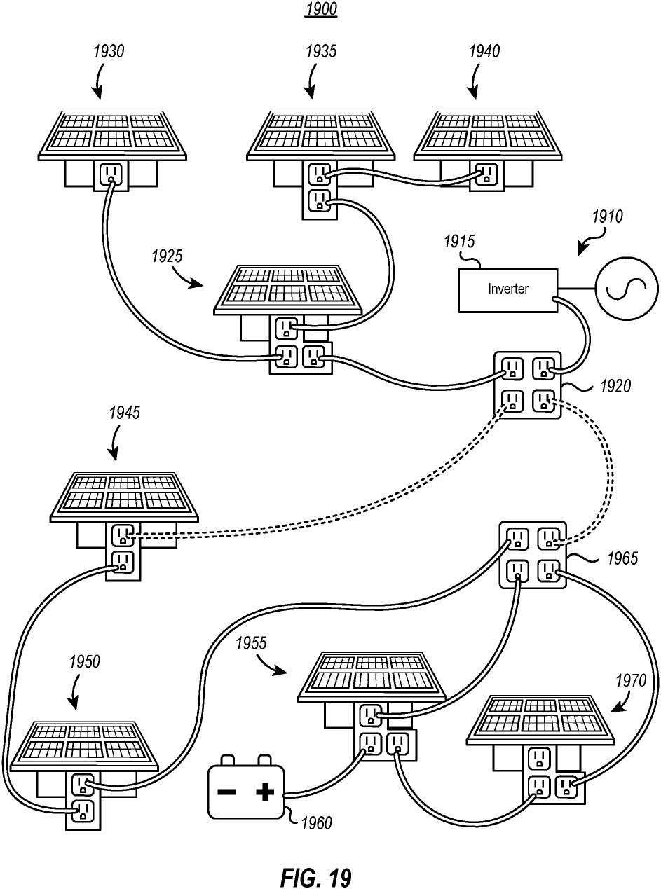

FIGS. 18 and 19 employ the same configuration of FIG. 17 and the same last two numerals are used to indicate the same element. For example, 1710, 1810, and 1910 refer to the power grid, and 1755, 1855, and 1955 refer to the 4-port power junction-solar device. With this same configuration of elements, FIGS. 18 and 19 show different scenarios. For example, one connection is lost or disconnected, and the following effects are described. Dotted lines in FIGS. 18 and 19 are used to show disconnection between two elements. However, when describing effects from one dotted line, the other dotted lines are assumed to be connected.

For example, in FIG. 18, there are five dotted lines. Firstly, when the 4-port power junction device 1820 is disconnected from the inverter 1815, the following effects are described. Under this situation, the other three dotted lines are considered to be connected. Since the connection to the power grid 1810 is lost, the whole peer-to-peer system is disconnected from the power grid, and all DC power generated by solar panels will be diverted to and saved in the battery 1860.

Secondly, when the 4-port power junction-solar device 1855 is disconnected from the battery 1860, all DC power generated by the solar panels will go to the inverter 1815, which converts the DC power to AC power and deliver to the power grid 1810.

Thirdly, when the 4-port power junction-solar device 1825 is disconnected from the 2-port power junction-solar device 1830, only the 2-port power junction-solar device 1830 is disconnected from the whole peer-to-peer system and the other elements in the peer-to-peer system 1800.

Next, when the 4-port power junction-solar device 1825 is disconnected from the 3-port power junction-solar device 1835, the 3-port power junction-solar device 1835 and the 2-port power junction-solar device 1840 are disconnected from the peer-to-peer system 1800 because of the serial connection.

Lastly, when the 3-port power junction-solar device 1835 is disconnected from the 2-port power junction-solar device 1840, only the 2-port power junction-solar device 1840 is disconnected from the peer-to-peer system 1800.

Now referring to FIG. 19, there are two dotted lines indicating that two connections are disconnected from the peer-to-peer system 1900. It is noted that in FIG. 17, any element in the redundant coupling is not lost when one connection is lost. However, in FIG. 19, two connections with the 4-port power junction device 1920 are lost, and thus the redundant coupling is lost. Thus, the 3-port power junction-solar device 1945, the 3-port power junction-solar device 1950, the 4-port power junction device 1965, the 4-port power junction-solar device 1955, the battery 1960, and the 4-port power junction-solar device 1970 are disconnected from the peer-to-peer system 1900. Nevertheless, all DC power generated by the 3-port power junction-solar device 1945, the 3-port power junction-solar device 1950, the 4-port power junction device 1965, the 4-port power junction-solar device 1955, and the 4-port power junction-solar device 1970 is saved in the battery 1960, thereby forming a standalone system. In other words, the peer-to-peer system 1900 is now two systems: one system with the serial connection and the other system being a standalone system.

Various other configurations may be made with serial or redundant couplings. Further, as described above, one or more disconnections may split one peer-to-peer system into two or more separate peer-to-peer systems including a standalone system.

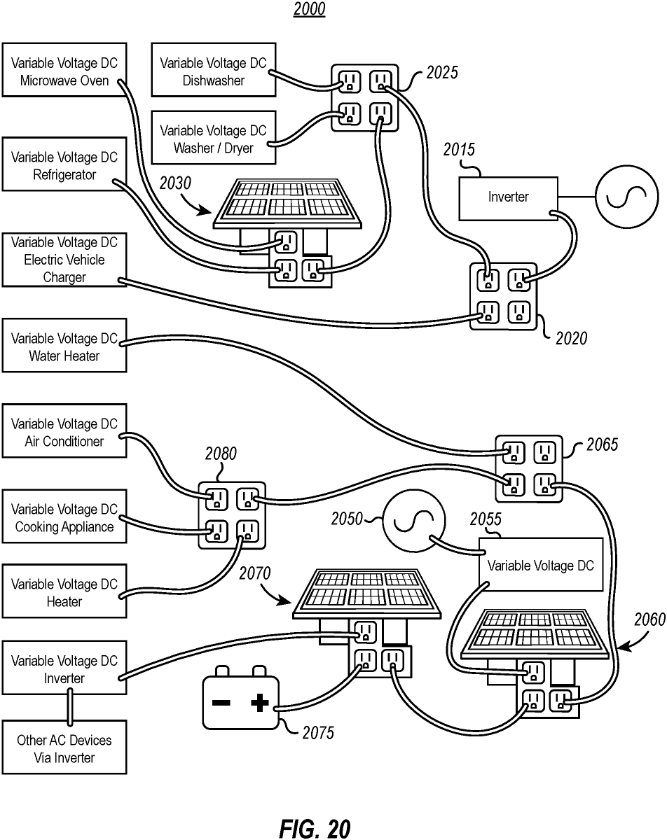

Attention is not directed to FIG. 20, which illustrates sample peer-to-peer systems. The top peer-to-peer system includes a power grid 2010 connected to an inverter 2015. The inverter 2015 converts DC power to AC power and feed the AC power to the power grid 2010. When power is needed, the AC power from the power grid 2010 may be converted to DC power by the inverter 2015 and transmitted to the peer-to-peer system. The inverter 2015 is serially connected to a 4-port power junction device 2020, a 4-port power junction device 2025, and a 4-port power junction-solar device 2030. As illustrated, the 4-port power junction device 2020 is connected to supply power to an electrical vehicle charger, the 4-port power junction device 2025 is connected to supply DC power to a dishwasher and a washer/dryer, and the 4-port power junction-solar device 2030 is connected to supply DC power to a microwave oven and a refrigerator.

The bottom peer-to-peer system includes a power grid 2050 connected to an inverter 2055. As in the top peer-to-peer system, the inverter 2055 is serially connected to a 4-port power junction-solar device 2060, a 4-port power junction device 2065, a 4-port power junction-solar device 2070, a battery 2075, and a 4-port power junction device 2080. An air conditioner, a cooking appliance, and a heater are connected to the 4-port power junction device 2080. In this peer-to-peer system, another inverter is connected to the 4-port power junction-solar device 2070 so that the inverter converts the DC power to AC power, which is then transmitted to or supplies the AC power to other AC devices.

In embodiment, other various configurations of serial and/or redundant couplings are also possible by persons having skill in the art to achieve performance required. Also, AC and DC appliances can be connected to the peer-to-peer system using inverters.

It should also be noted how the panels are able to work out of the box. A power junction device can be installed on a panel as described herein. Using the disclosed power junction device, solar panels or arrays can be easily combined with one another using standard extension cords. The embodiments also allow for the portable use of solar panels. Furthermore, the power junction device can be installed on existing solar panels already installed on a structure or on the ground.

### Additional Embodiments

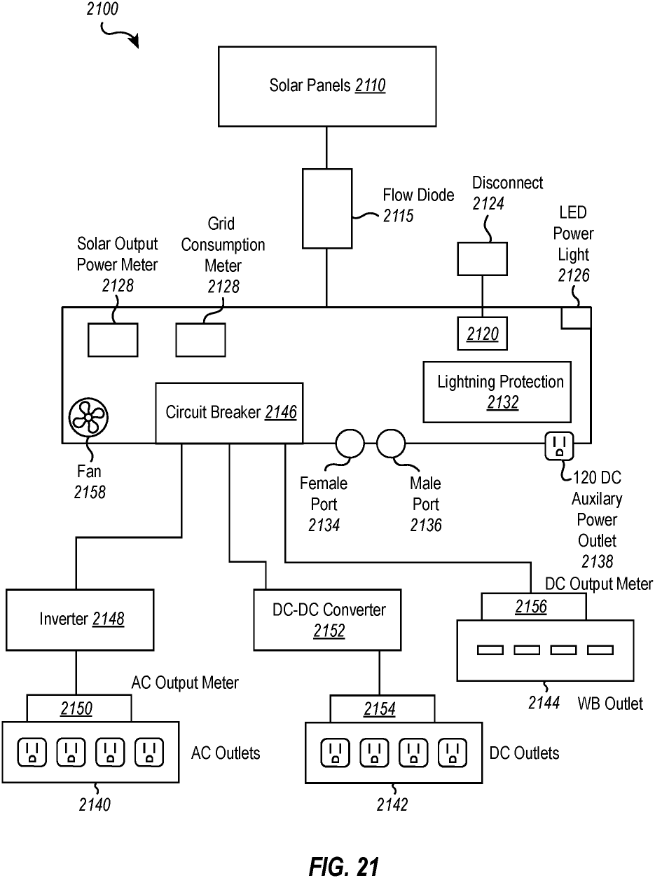

FIG. 21 shows a schematic diagram of a power system 2100 using a power junction device 2120 according to embodiments of the present disclosure. The power junction device 2120 may be referred to as a mini mimic device because the whole size thereof is minimized and the power junction device 2120 may be is

in the form of a removable and highly portable extension cord.

One or more solar panels 2110 may be connected to the power junction device 2120. To prevent back flow of current, a reverse flow diode 2115 is placed between the power junction device 2120 and the solar panels. In an aspect, the solar panels 2110 may be any other renewable energy sources or a battery. The power junction device 2120 may include additional electrical components.

In some embodiments, the power junction device 2120 may include a bus disconnect 2124 that, when switched, disconnects power to the entire power system 2100. In embodiments, the power junction device 2120 can include a circuit breaker for each input, a power LED light 2126 to show whether the power junction device 2120 is powered, and a DC auxiliary power outlet 2138. Various DC devices can be connected to the DC auxiliary power outlet 2138 to receive power.

In some embodiments, the power junction device 2120 may include a lightning protection circuit 2132. In some cases, a lightning grounding rod may be included with the power junction device 2120, and that rod can be inserted into the ground. In some cases, multiple rods can be used.

As one example, suppose a single 8-foot rod was used. This rod can be inserted into the ground and provide a grounding source for lightning protection. As another example, suppose one-foot rods were used. These separate rods could each be inserted into the ground and provide lightning protection as a parallel unit.

The power junction device 2120 may include both a DC outlets 2142, an AC outlets 2140, and USB outlets 2144. Further details on the generation of the AC output will be provided later.

In embodiments, the power junction device 2120 may include a solar output power meter 2128, which can measure the output power of the solar panels 2110. This solar output power meter 2128 can optionally be disposed within the same housing of the power junction device 2120 as the circuit breakers 2146 are used to control the DC outlets 2142, the AC outlets 2140, and the USB outlets 2144.

In an embodiment, the power junction device 2120 may include a bus meter 2122, which measures and displays the voltage and/or power on the bus. The bus disconnect 2124 is able to disconnect the power from the power junction device 2120. The power junction device 2120 further includes a grid consumption meter 2130 to measure the power that is being consumed.

The solar output power meter 2128also displays the amount of power being consumed by external devices. The USB outlets 2144 provide DC power to USB ports. Between the circuit breaker 2146 and the USB outlets 2144, a DC output meter 2156 may be positioned. The DC output meter 2156 may measure DC power consumed by the USB outlets 2144 and display the DC power consumption. Further, the DC output meter 2156 may act as a switch to cut off the DC power when the DC power consumption exceeds the capacity of the USB outlets 2144.

In embodiments, the power junction device 2120 may include daisy chain connection terminals 2134 and 2136 to connect multiple power junction devices together. Specifically, the daisy chain connection terminal 2134 is a male connector and the daisy chain connection terminal 2136 is a female connector. By connecting the female connector 2136 to another female connector of another power junction device and connecting the male connector 2134 to another male connector of another power junction device, a daisy chain may be made.

Between the circuit breaker 2146 and the DC outlets 2142, a DC-to-DC converter 2152 may be placed to convert the variable volt DC to steady state DC, such as 5 V, 12 V, 24 V, 48 V, or any other required DC voltage. Further, a DC output meter 2154 may be electrically coupled with the DC outlets 2142 to measure DC power consumption through the DC outlets 2142. The DC output meter 2154 may act as a switch to turn off the power when the consuming power exceed the capacity of the DC outlets 2142.

Between the circuit breaker 2146 and the AC outlets 2140, an inverter 2148 is placed to convert the DC power into AC power having the characteristics of a local power grid. For instance, if the local power grid outputs 120 V AC power at 60 Hz, then the inverter 2148 can perform a conversion to output a similar power signal. Of course, any other signal type can be generated by the inverter 2148 to match the characteristics of the local power grid.

In an embodiment, an AC output meter 3005 is disposed between the inverter 2148 and the AC outlets 2140. The AC output meter 2150 displays the output of the inverter 2148 and measures AC power consumption through the AC outlets 2140. The inverter 2148 or the AC output meter 2150 may works as an AC on/off switch. When the AC on/off switch is off, the AC outlets 2140 is not powered. Manipulating the AC on/off switch 3100 will control whether the AC outlets 2140 is energized.

In an embodiment, the power junction device 2120 may include a fan 2158, which circulates air or cooling agent within the power junction device 2120 so that the power junction device 2120 maintains a range of temperature suitable for all components within or nearby the power junction device 2120

FIG. 21 shows various features of the power junction-solar device in the upright position according to embodiments. Specifically, FIG. 32 shows three solar panels 2210, 2220, and 2230. Hinges 2250a and 2250b connects two adjacent solar panels together. For example, the hinges 2250a connects the end sections of two curved portions of two top bars. A straight portion of each top bar is fixedly attached to the top portion of the rear side of a solar panel. The hinges 2250b connects the end sections of two curved portions of two bottom bars. A straight portion of each bottom bar is fixedly attached to the bottom portion of the rear side of a solar panel.

Specifically, to fold the solar panels, the solar panel 2210 is folded along the arrow so that the front side of the solar panel 2210 faces the front side of the solar panel 2220, and the solar panel 2230 is folded along the arrow so that the front side of the solar panel 2230 faces the rear side of the solar panel 2210. While folding the solar panels 2210, 2220, and 2230, the top and bottom hinges 2250a and 2250b help folding them in a specific way so that they do not tilt. Thus, when folded, the solar panels 2210, 2220, and 2230 are well stacked together with a bearable tilt from each other.

Further, the curved portion of each top and bottom bar may have an angle of 30°, 45°, 60°, or any other suitable angle for folding two solar panels. The curved portion in the bar is beneficial because it imposes a separation distance between the solar panels when the solar panels are in a folded state. This separation distance has the benefit of allowing a user to easily grab the solar panels to unfold them as well as to prevent a possible finger pinch accident. Also, the separation distance helps prevent one solar panel from scratching or otherwise damaging another solar panel. For example, when the solar panel 2230 is folded over to the read side of the solar panel 2210, the separation distance based on the curved portion is sufficiently large enough so that three solar panels 2210, 2220, and 2230 are well stacked.

With the hinges, a plurality of solar panels can be connected together, and the hinges allow those solar panels to be folded into one another. Different numbers of solar panels can be connected via the hinges. Examples of the number of connected solar panels include 2, 3, 4, 5, or even 6 solar panels. As described above, the curved portions of bars are generally bent or have an angle to allow a sufficient amount of room between the solar panels when they are in the collapsed or folded position.

At the base of the solar panel 2220 is a set of wheels 2260.

A single set of wheels 2260 can be used to then wheel the entire unit to different locations in an easy manner. The embodiments also include a support stand 2270 to allow the solar panels to be positioned at different angles relative to the direction of the sun. It is generally desirable to position the solar panels at a perpendicular direction relative to the sun’s rays. The support stand 2270 includes multiple telescopic positions that allow the unit to be angled at different angles. A mimic device or power junction device 2240 may be attached or disposed to the rear side of the solar panel 2220.

The support stand 2270 can include or be integrated with a support unit 2280, such as a chain or cable. This support unit 2280 can further help adjust the angle of the solar panels with respect to the ground so as to receive maximum solar energy from the sun.

In an embodiment, the support stand 2270 may have a wheel at the bottom thereof so that the adjustment of angle may be easily made.

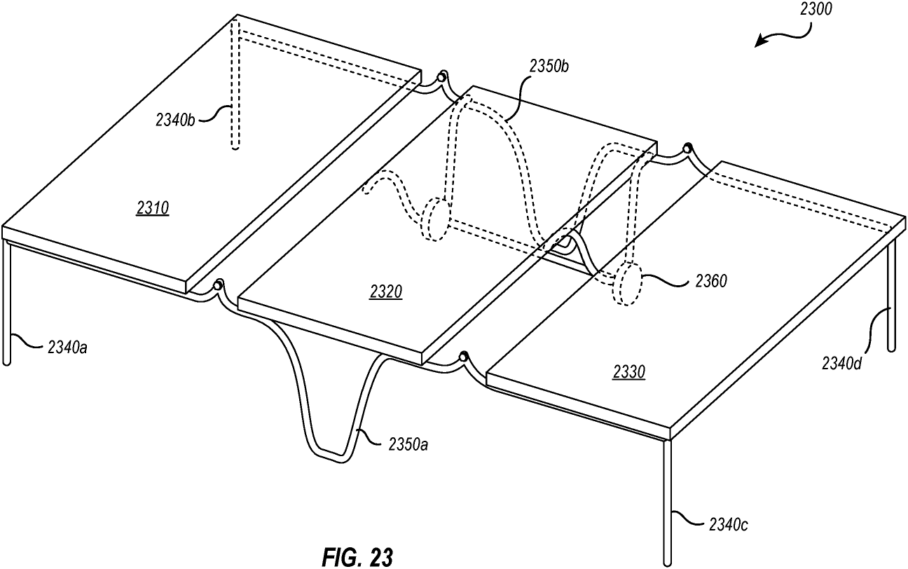

FIG. 23 shows various features of a power junction-solar device 2300 in horizonal position according to embodiments. When solar panels are not automatically adjusting the angle or tilt to follow the sun, the horizontal position of the solar panels may be better to receive solar energy from the sun than other angles. Based on the inclination of the ground or rooftop, the angle of the solar panels with respect to the ground may be adjusted to maximize reception of the solar energy.

In this regard, the power junction-solar device 2300 includes three solar panels 2310, 2320, and 2330. One side solar panel 2310 may include two support legs 2340a and 2340b and the other side solar panel 2330 may include two support legs 2340c and 2340d. The support legs 2330a, 2330b, 2340a, and 2340b can drop down when the solar panels are unfolded. This support legs 2330a, 2330b, 2340a, and 2340b can include telescopic features to adjust the height so as to adjust an angle of the solar panels with respect to the ground.

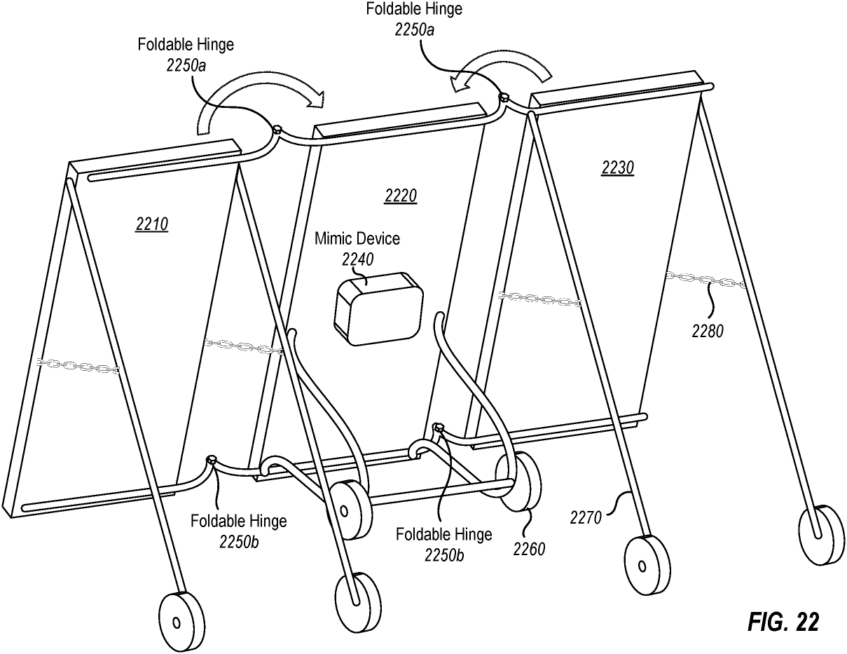

The power junction-solar device 2300 also includes hinges and bars connected to the hinges. The descriptions of the hinges and bars are same or at least similar to the hinges and bars of FIG. 22 above, and thus are omitted for FIG. 23.

Unlike the central solar panel 2220 of FIG. 22, the central solar panel 2320 includes a stand 2350a in the front and a stand 2350b in the back, which have a V or U shape. The stands 2350a and 2350b may be support legs such as 2340a and 2340b. When the solar panels are folded, two wheels 2360 in the back can make easy transportation to different places.

As illustrated in FIG. 22, the power junction device (now shown in FIG. 23) may be removably attached to the rear side of the central solar panel 2320. The power junction device may be one shown in FIG. 21. Not every element in the power junction device 2120 may be included in the power junction device 2240 because there are only three solar panels. However, when there are 4 or more number of solar panels with complex configurations, every element shown in the power junction device 2120 may be included in the power junction device 2240.

Thus, the power junction device 2240 and the solar panels can provide a standalone power system at a remote location where the power grid cannot provide power or can be installed at or over a vehicle so that the power can be provided wherever the vehicle is driven. Further, the standalone system can be installed on a rooftop or over a carport of a residential or business establishment.

Optionally, the various components can be located at positions to enable easy access, even when the unit is in different positions. For instance, the output ports (e.g., AC or DC outlets) can be positioned near the edges of the solar panels to allow a user to easily reach those ports, regardless of whether the unit is in an upright position or an angled position. Similarly, the disconnects and/or on/off switches can be located near the edges of the solar panels to allow easy access.

The disclosed embodiments beneficially provide a branch circuit outlet that can be powered by any number of different solar panels. The outlets can be configured as DC power or AC power. The AC outlet, using the disclosed principles, can be powered with anywhere from 1,000 W up to about 4,000 W. Different voltages and amperages can also be achieved, such as 110 V at 15A and 220 V at 30A. The embodiments are able to simultaneously provide DC power and AC power. Some embodiments are packaged as a removable kit that can be attached to a solar panel. This kit can include the mimic as well as the various other components (e.g., the DC-to-DC converter, the AC inverter, the outlet plugs, etc.). Thus, the kit can be provided, at least initially, separately from the solar panels. The kit can optionally be attached to other power sources as well, such as a wind turbine.

Different types of devices can also be connected and powered by the disclosed units. For instance, a water pump can be connected, and the water pump can be used to pump water. Optionally, a water cooling system for the unit can also be used and powered by the unit itself. Optionally, a water collection gutter can even be disposed on a bottom section of the solar panel to collect or direct water when it rains.

Some embodiments include motorized wheels that enable self-driving when moving the unit. The wheels can optionally be remote controlled, such as via an RF remote control or perhaps a Bluetooth control (e.g., via a Smart Phone).

The embodiments can also include a roof or trailer mount. It is possible to take the solar panels off of a roof and use a kit to convert those roof panels to portable panels. In some cases, the panels may optionally not have a mimic device on them. Instead, those panels might have only an inverter and an outlet and might take power from only the local panels. Some of the disclosed solar panels are flexible and can produce around 200 watts. Some flexible panels can produce up to about 400 watts.

A 500 watt output panel can run many things without a mimic (aka peer to peer power grid). That being said, by introducing the mimic, many more things can now be powered by solar panels. The units are beneficially structured or designed to be highly portable and can be hauled by a person, a trailer, an ATV, or perhaps even a car. Some of the disclosed embodiments are made from hard panels, and these units can then be made to be highly portable, which is something that the traditional technology has not achieved (e.g., portable hard panels).

Some embodiments incorporate the use of a floatation device or a floatation barge in lieu of the wheels. This floatation device can be used to transport the solar panels and mimic to various different locations. In some cases, the size of the floatation device can correspond to the size of the solar panel set when in an unfolded or deployed state. Any number of these floatation devices can be strung together behind a boat for electrical power. It is also possible to create a floating dock in a lake where there is no grid power access and have these “solar barges” provide power. The solar panels can connect together in a daisy chain manner. The units can optionally include a propulsion system to allow a floating power grid to drive to a destination. The unit can also use propulsion to remain in a constant position on a body of water regardless of wind, water, or drag.

### Example Implementations

In view of the foregoing, the present invention relates, for example and without being limited thereto, to the following aspects:

In a first aspect, a power junction device (e.g., a mimic device) is configured to receive variable power from a set of renewable power sources and is configured to provide that variable power to a receiving device. The power junction device comprises an electrical junction comprising a first panel lead and a second panel lead, wherein the first panel lead is configured to connect to a downstream of the set of renewable power source and to receive the variable power generated by the set of renewable power sources, and the second panel lead is configured to connect to an upstream of the set of renewable power sources. The power junction device further comprises a load disconnect electrically coupled to the electrical junction and configured to prevent arcing when opening or closing a circuit powered by the variable power. The power junction device further includes a first connector configured to parallelly connect to another power junction device. The power junction device further includes a second connector electrically coupled to the receiving device and configured to provide the variable power to the receiving device.

In a second aspect of the power junction device as recited in any of the preceding aspects, the power junction device is electro-magnetic pulse (EMP) proof.

In a third aspect of the power junction device as recited in any of the preceding aspects, the power junction device includes a power output meter configured to display an amount of power generated by the set of renewable power sources.

In a fourth aspect of the power junction device as recited in any of the preceding aspects, the power junction device includes a power consumption meter configured to display an amount of power consumption by the receiving device.

In a fifth aspect of the power junction device as recited in any of the preceding aspects, the receiving device is configured to be powered using direct current (DC) power, or alternating current (AC) power.

In a sixth aspect of the power junction device as recited in any of the preceding aspects, the power junction device is detachably connected to one of the set of renewable power sources.

In a seventh aspect of the power junction device as recited in any of the preceding aspects, the set of renewable power sources are a set of solar panels.

In an eighth aspect of the power junction device as recited in any of the preceding aspects, the set of solar panels includes three solar panels.

In a ninth aspect of the power junction device as recited in any of the preceding aspects, each solar panel in the set of solar panels includes a support stand to enable the set of solar panels to stand in a non-parallel manner relative to a surface on which the set of solar panels are disposed.

In a tenth aspect of the power junction device as recited in any of the preceding aspects, the power junction device is detachably connected to a rear side of one of the set of solar panels.

In an eleventh aspect of the power junction device as recited in any of the preceding aspects, the set of solar panels includes a first solar panel, a second solar panel, and a third solar panel, wherein a first back-feed diode is associated with the first solar panel, a second back-feed diode is associated with the second solar panel, a third back-feed diode is associated with the third solar panel, wherein the first back-feed diode is electrically coupled to the second back-feed diode, and the second back-feed diode is electrically coupled to the third back-feed diode such that the first back-feed diode, the second back-feed diode, and the third back-feed diode are connected in series with one another, and wherein a first electrical wire connects the power junction device to the third back-feed diode, and a second electrical wire connects the power junction device to the first back-feed diode.

In a twelfth aspect, a power generation system is configured to generate and provide power. The power generation system comprises a set of renewable power sources configured to generate power. The power generation system further comprises a power junction device electrically coupled to the set of renewable power sources and configured to receive variable power from the set of renewable power sources and to provide the variable power to a receiving device. The power junction device includes an electrical junction comprising a first panel lead and a second panel lead, wherein the first panel lead is configured to connect to a downstream of the set of renewable power source and to receive the variable power generated by the set of renewable power sources, and the second panel lead is configured to connect to an upstream of the set of renewable power sources. The power junction device further comprises a load disconnect electrically coupled to the electrical junction and configured to prevent arcing when opening or closing a circuit powered by the variable power. The power junction device further includes a first connector configured to parallelly connect to another power junction device. The power junction device further includes a second connector electrically coupled to the receiving device and configured to provide the variable power to the receiving device.

In a thirteenth aspect of the power generation system as recited in the twelfth aspects, the set of renewable power sources generates variable DC power.

In a fourteenth aspect of the power generation system as recited in any of the preceding aspects to the twelfth aspect, the power junction device further comprises one or more DC outlets and/or one or more AC outlets.

In a fifteenth aspect of the power generation system as recited in any of the preceding aspects to the twelfth aspect, the power junction device further comprises a DC-to-DC converter configured to convert the variable DC power to DC power suitable for devices connected to the one or more DC outlets.

In a sixteenth aspect of the power generation system as recited in any of the preceding aspects to the twelfth aspect, the power junction device further comprises an inverter configured to invert the variable DC power to an AC power suitable for devices connected to the one or more AC outlets.

In a seventeenth aspect of the power generation system as recited in any of the preceding aspects to the twelfth aspect, the power junction device further comprises circuit breakers for the one or more DC outlets and/or the one or more AC outlets.

In an eighteenth aspect of the power generation system as recited in any of the preceding aspects to the twelfth aspect, the power junction device further comprises a lightning prevention device configured to protect the power junction device from lightning.

In a nineteenth aspect of the power generation system as recited in any of the preceding aspects to the twelfth aspect, the power junction device further comprises a status indicator indicating presence or absence of power therein.

In a twentieth aspect of the power generation system as recited in any of the preceding aspects to the twelfth aspect, the power junction device further comprises a ventilation system configured to cool down the power junction device.

In a twenty first aspect of the power generation system as recited in any of the preceding aspects to the twelfth aspect, the power generation system further comprises a second set of renewable power sources configured to generate power, and a second power junction device electrically coupled to the second set of renewable power sources and configured to receive variable power from the second set of renewable power sources and to provide the variable power to another receiving device. The second power junction device is electrically connected to the power junction device such that the power generated by the renewable power sources and the power generated by the second set of renewable power sources are shared between the power junction device and the second power junction device.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A power junction device configured to receive variable power from a set of renewable power sources and to provide that variable power to a receiving device, the power junction device comprising:
an electrical junction comprising a first panel lead and a second panel lead, wherein the first panel lead is configured to connect to a downstream of the set of renewable power sources and to receive the variable power generated by the set of renewable power sources and the second panel lead is configured to connect to an upstream of the set of renewable power sources;
a load disconnect electrically coupled to the electrical junction and configured to prevent arcing when opening or closing a circuit powered by the variable power;
a first connector configured to parallelly connect to another power junction device; and
a second connector electrically coupled to the receiving device and configured to provide the variable power to the receiving device.

2. The power junction of claim 1, wherein the receiving device is configured to be powered using direct current (DC) power or alternating current (AC) power.

3. The power junction device of claim 1, wherein the power junction device is detachably connected to one of the set of renewable power sources.

4. The power junction device of claim 1, wherein the set of renewable power sources are a set of solar panels.

5. The power junction device according to claim 4, wherein the set of solar panels includes three solar panels.

6. The power junction device of claim 4, wherein each solar panel in the set of solar panels includes a support stand to enable the set of solar panels to stand in a non-parallel manner relative to a surface on which the set of solar panels are disposed.

7. The power junction device of claim 4, wherein the power junction device is detachably connected to a rear side of one of the set of solar panels.

8. The power junction device of claim 4, wherein the set of solar panels includes a first solar panel, a second solar panel, and a third solar panel,
wherein a first back-feed diode is associated with the first solar panel, a second back-feed diode is associated with the second solar panel, a third back-feed diode is associated with the third solar panel,
wherein the first back-feed diode is electrically coupled to the second back-feed diode, and the second back-feed diode is electrically coupled to the third back-feed diode such that the first back-feed diode, the second back-feed diode, and the third back-feed diode are connected in series with one another, and
wherein a first electrical wire connects the power junction device to the third back-feed diode, and a second electrical wire connects the power junction device to the first back-feed diode.

9. A power generation system for generating and providing power, the power generation system comprising:
a set of renewable power sources configured to generate power;
a power junction device electrically coupled to the set of renewable power sources and configured to receive variable power from the set of renewable power sources and to provide the variable power to a receiving device, the power junction device comprising:
an electrical junction comprising a first panel lead and a second panel lead, wherein the first panel lead is configured to connect to the set of renewable power sources and to receive the variable power generated by the set of renewable power sources and the second panel lead is configured to connect to an upstream of the set of renewable power sources;
a load disconnect electrically coupled to the electrical junction and configured to prevent arcing when opening or closing a circuit powered by the variable power;
a first connector configured to parallelly connect to another power junction device; and
a second connector electrically coupled to the electrical junction and configured to provide the variable power to the receiving device.

10. The power generation system according to claim 9, wherein the power junction device further comprises an inverter configured to invert the variable DC power to an AC power suitable for devices connected to the one or more AC outlets.

11. The power generation system of claim 9, wherein the power junction device further comprises circuit breakers for the one or more DC outlets and/or the one or more AC outlets.

12. The power generation system of claim 9, wherein the power junction device further comprises a lightning prevention device configured to protect the power junction device from lightning.

13. The power generation system of claim 9, wherein the power junction device further comprises a status indicator indicating presence or absence of power therein.

14. The power generation system of claim 9, wherein the power junction device further comprises a ventilation system configured to cool down the power junction device.

15. The power generation system of claim 9, further comprising:
a second set of renewable power sources configured to generate power;
a second power junction device electrically coupled to the second set of renewable power sources and configured to receive variable power from the second set of renewable power sources and to provide the variable power to another receiving device,
wherein the second power junction device is electrically connected to the power junction device such that the power generated by the renewable power sources and the power generated by the second set of renewable power sources are shared between the power junction device and the second power junction device.

16. A power generation system for generating and providing power, the power generation system comprising:
a set of renewable power sources configured to generate power;
a power junction device electrically coupled to the set of renewable power sources and configured to receive variable power from the set of renewable power sources and to provide the variable power to a receiving device, the power junction device comprising:
an electrical junction comprising a first panel lead and a second panel lead, wherein the first panel lead is configured to connect to the set of renewable power sources and to receive the variable power generated by the set of renewable power sources and the second panel lead is configured to connect to an upstream of the set of renewable power sources;
a load disconnect electrically coupled to the electrical junction and configured to prevent arcing when opening or closing a circuit powered by the variable power;
a first connector configured to parallelly connect to another power junction device; and
a second connector electrically coupled to the electrical junction and configured to provide the variable power to the receiving device,
wherein the power junction device is detachably connected to a rear side of one of the renewable power sources.

17. The power generation system according to claim 16, wherein the power junction device further comprises an inverter configured to invert the variable DC power to an AC power suitable for devices connected to the one or more AC outlets.

18. The power generation system of claim 16, wherein the power junction device further comprises circuit breakers for the one or more DC outlets and/or the one or more AC outlets.

19. The power generation system of claim 16, wherein the power junction device further comprises a lightning prevention device configured to protect the power junction device from lightning.

20. The power generation system of claim 16, wherein the power junction device further comprises a status indicator indicating presence or absence of power therein.
